(19) United States
(12) Patent Application Publication
(10) Pub. No.: US 2005/0002288 A1
(43) Pub. Date: Jan. 6, 2005

(54) Optical pickup device and method for controlling the same

(76) Inventor: Hirofumi Suzuki, Higashihiroshima-shi (JP)

Correspondence Address: MORRISON & FOERSTER LLP, 755 PAGE MILL RD, PALO ALTO, CA, 94304-1018, US

(21) Appl. No.: 10/826,588

(22) Filed: Apr. 16, 2004

(30) Foreign Application Priority Data
Apr. 17, 2003 (JP) 2003-113343

(51) Int. Cl. G11B 7/00

(52) U.S. Cl. 369/44.23; 369/44.41; 369/112.01

(57) ABSTRACT

An optical pickup device includes a light source for emitting light to an Information recording medium; a light detector including a plurality of light receiving portions, the light detector receiving light reflected by the information recording medium by the plurality of light receiving portions so as to detect information represented by the reflected light; and a correction optical device section including a correction optical device for correcting a light path of the reflected light before the plurality of light receiving portions receive the reflected light, and a correction optical device control section for controlling the correction optical device such that a ratio of a light spot received by the plurality of light receiving portions is a prescribed value.

This non-provisional application claims priority under 35 U.S.C., §119(a), on Patent Application No. 2003-113343 filed in Japan on Apr. 17, 2003, the entire contents of which are hereby incorporated by reference.

### BACKGROUND OF THE INVENTION

1. Field of the Invention

The present invention relates to an optical pickup device and a method for controlling the optical pickup device. More specifically, the present invention relates to an optical pickup device for reproducing or erasing information from, and recording information on, an information recording medium such as, for example, an optical disc or an optomagnetic disc; and a method for controlling such an optical pickup device.

2. Description of the Related Art

Conventionally, a technology for irradiating an optical disc with an optical beam emitted by a light source and receiving the light reflected by the optical disc by a receiving section so as to reproduce and read information which is recorded on the optical disc is known. This technology is widely used in actual products such as optical disc recording and reproduction apparatuses including CD (compact disc) recording and reproduction apparatuses and DVD (digital versatile disc) recording and reproduction apparatuses.

In such an optical disc recording and reproduction apparatus, which is one type of information recording and reproduction apparatuses, an optical pickup device works as follows. An optical beam which is output from a light source such as a semiconductor laser device or the like is converged by an objective lens and directed to a signal recording surface of an optical disc. Various information represented by light reflected by the optical disc, is detected by an optical detector. Thus, information recorded on the optical disc is reproduced and read.

FIG. 7 is a schematic view of a conventional optical pickup device 20.

On the optical pickup device 20, an optical disc 21 is mounted. The optical pickup device 20 includes a plurality of optical elements. More specifically, the optical pickup device 20 includes an objective lens 22 for converging light, a collimator lens 23 for collimating light, a prism 24 for changing the optical path of light incident thereon in one direction by 90 degrees and allowing light incident thereon in a different direction to transmit therethrough, a diffraction grating 25 for diffracting light, a light source 26 such as a semiconductor laser device or the like, a cylindrical lens 27 for causing astigmatism to light transmitted therethrough, and a light detector 28 for receiving light reflected by the optical disc 21 and detecting information represented by the reflected light.

The optical pickup device 20 operates as follows. An optical beam which is emitted by the light source 26 passes through the diffraction grating 25 and is incident on the prism 24. The direction of the light is changed by the prism 24 by 90 degrees, and the light is incident on the collimator lens 23. The light is collimated by the collimator lens 23 and then is converged by the objective lens 22. The light then irradiates the optical disc 21. On the optical disc 21, a small light spot is formed.

The light which is reflected by the optical disc 21 passes through the objective lens 22 and is incident on the collimator lens 23. Then, the light passes through the collimator lens 23 and is incident on the prism 24. The light passes through the prism 24 and advances straight. Astigmatism is caused to the light by the cylindrical lens 27, and then the light reaches the light detector 28.

The light detector 28 has a light receiving surface which is divided into a plurality of light receiving portions. The light detector 28 has, for example, four light receiving portions, which are arranged to be adjacent to each other.

The four light receiving portions and the optical elements included in the optical pickup device 20 are arranged such that when light Is collected on the optical disc 21 with no focal offset and a light spot is positioned at the center of a track on the optical disc 21, the four light receiving portions receive the light at a prescribed ratio. For example, the four light receiving portions receive an equal amount of light.

In this specification, the light spot being formed on the surface of the light receiving portions is also expressed as “the light spot being received by the light receiving portions”.

The light reflected by the optical disc 21 and received by each of the four light receiving portions of the light detector 28 is converted into an electric signal. By arithmetic processing of the electric signal, the information (reproduction information) recorded on the optical disc 21 and servo information are detected. Based on the detected information, the information recorded on the optical disc 21 is reproduced or erased, or information is recorded on the optical disc 21.

In the optical pickup device 20, the optical elements such as the collimator lens 23, the prism 24, the diffraction grating 25, the light source 26, the is cylindrical lens 27 and the light detector 28 may be positionally deviated due to long-time use or environmental changes. When this occurs, the ratio of the light spot (i.e., the ratio of the areas of the light spot) received by the respective light receiving portions of the light detector 28 is changed from a prescribed value (for example, an initially set value). As a result, tracking servo control is not normally performed, and thus information cannot be accurately read from the optical disc 21.

In order to avoid this, Japanese Laid-Open Publication No. 2-192029, for example, discloses an optical head operating as follows. In accordance with focusing error information representing a focusing error or tracking error information representing a tracking error, the objective lens is driven in prescribed directions (X, Y, Z directions). Immediately before adjusting the focusing position or tracking position, a search of a surface of the optical disc is performed while moving the objective lens by an actuator so as to detect an offset amount of each light receiving element. In accordance with the offset amount, the position of each light receiving element is adjusted.

As described above, the conventional optical pickup device 20 has the problem in that when the ratio of the light spot received by the light receiving portions (i.e., the light spot formed on the surface of the light receiving portions) is changed after the positions of the optical elements including the light detector 28 are adjusted, tracking servo control cannot be normally performed. Therefore, the positions of the optical elements need to be adjusted again.

### SUMMARY OF THE INVENTION

According to one aspect of the invention, an optical pickup device includes a light source for emitting light to an information recording medium; a light detector including a plurality of light receiving portions, the light detector receiving light reflected by the information recording medium by the plurality of light receiving portions so as to detect information represented by the reflected light; and a correction optical device section including a correction optical device for correcting a light path of the reflected light before the plurality of light receiving portions receive the reflected light, and a correction optical device control section for controlling the correction optical device such that a ratio of a light spot received by the plurality of light receiving portions is a prescribed value.

In one embodiment of the invention, the correction optical device section is located on a portion of a light path from the information recording medium to the plurality of light receiving portions, the portion not overlapping with a light path from the light source to the information recording medium.

In one embodiment of the invention, the correction optical device Includes a flat plate-like transparent member or a concaved lens.

In one embodiment of the invention, the correction optical device includes a focusing error generation optical device for causing a focusing error to the reflected light.

In one embodiment of the invention, the focusing error generation optical device includes a cylindrical lens.

In one embodiment of the invention, the optical pickup device further includes a focusing error generation optical device, located on the optical path from the information recording medium to the plurality of light receiving portions, for causing a focusing error to the reflected light.

In one embodiment of the invention, the focusing error generation optical device includes an astigmatism generation device for causing an astigmatism to the reflected light. The plurality of light receiving portions receive the reflected light to which the astigmatism is caused by the astigmatism generation device, and thus the light detector detects focusing error information representing the focusing error.

In one embodiment of the invention, the focusing error generation optical device includes a cylindrical lens.

In one embodiment of the invention, the correction optical device control section adjusts an angle of the correction optical device to correct the light path of the reflected light.

In one embodiment of the invention, the correction optical device control section includes a location angle control section for controlling the angle of the correction optical device with respect to a horizontal direction.

In one embodiment of the invention, the location angle control section includes a correction optical device driving section for changing the angle of the correction optical device with respect to the horizontal direction; and a control section for controlling the correction optical device driving section in accordance with the ratio of the light spot received by the plurality of light receiving portions.

In one embodiment of the invention, the correction optical device driving section includes a coil member provided at an end of the correction optical device; and a magnet member provided so as to face the coil member; and the control section controls an electric current to be supplied to the coil member to generate a magnetic force between the coil member and the magnet member, so as to control the correction optical device driving section to change the angle of the correction optical device with respect to the horizontal direction.

In one embodiment of the invention, the optical pickup device further includes a knife edge-like member having a pierced tip located at a position at which the reflected light is converged on the light path from the information recording medium to the plurality of light receiving portions. The knife edge-like member causes a focusing error to the reflected light. The plurality of light receiving portions receive the reflected light to which the focusing error is caused by the knife edge-like member, and thus the light detector detects focusing error information representing the focusing error.

In one embodiment of the invention, the optical pickup device further includes an objective lens, located on a light path from the light source to the information recording medium, for converging the light emitted by the light source on a surface of the information recording medium.

According to another aspect of the invention, a method for controlling an optical pickup device includes the steps of correcting a light path of light reflected by an information recording medium by a correction optical device such that a ratio of a light spot received by the plurality of light receiving portions is a prescribed value; and fixing the correction optical device which has corrected the light path of the reflected light.

In one embodiment of the invention, the step of correcting includes the step of adjusting an angle of the correction optical device with respect to a horizontal direction.

In one embodiment of the invention, the method further includes the step of locating the correction optical device on a portion of a light path from the information recording medium to the plurality of light receiving portions, the portion not overlapping with a light path from the light source to the information recording medium.

In one embodiment of the invention, the method further includes the step of adjusting a distance between an objective lens and a surface of the information recording medium, the objecting lens being located on a light path from the light source to the information recording medium, such that the light emitted by the light source is converged on the surface of the information recording medium before the step of correcting.

The present invention provides an optical pickup device for receiving light reflected by an information recording medium such as, for example, an optical disc or an optomagnetic disc by a plurality of light receiving portions of a light detector, and detecting focusing error information by an astigmatism method or a knife edge method. According to the present invention, a correction optical device such as a transparent flat plate member, a concaved lens, or a cylindrical lens is provided on an optical path from the information recording medium to the plurality of light receiving portions. When the ratio of the light spot received by the light receiving portions is offset from a prescribed value (e.g., an initially set value), the angle of the correction optical device with respect to the horizontal direction is adjusted based on the information detected by the light detector. Thus, the offset value is returned to the prescribed value. The correction optical device is provided on a portion of the optical path from the information recording medium to the plurality of light receiving portions, which does not overlap with an optical path from the light source to the information recording medium. Therefore, the correction optical device does not influence the light from the light source to the information recording medium.

For example, by causing an electric current to flow through a coil member provided at an end of the correction optical device, a magnetic force is generated between the coil member and a magnet member. The magnet member is attached to a holding member for holding the correction optical device so as to face the coil member. Thus, the angle of the correction optical device with respect to the horizontal direction can be electrically controlled. Such angle control may be performed by inputting a control signal from an external device, but may be performed by an internal control circuit.

Thus, the invention described herein makes possible the advantages of providing an optical pickup device which, even when the ratio of the light spot received by a plurality of light receiving portions of a light detector is offset from a prescribed value, can adjust the ratio to the prescribed value and thus can be used for a long time, and a method for controlling the optical pickup device in such a manner.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic view of an optical pickup device in one example according to the present invention;

FIG. 2 shows a cross-sectional view of the optical pickup device shown in FIG. 1 while the light receiving balance is being adjusted (part (a)); and a partial enlarged view thereof (part (b));

FIG. 3 is a schematic view of a correction optical device section included in the optical pickup device in one example according to the present invention;

FIGS. 4A and 4B are each a plan view of a light detector including four light receiving portions;

FIG. 5A is a side view of the correction optical device seen in the same direction as FIG. 1, illustrating an operation thereof while the light receiving balance is being adjusted;

FIG. 5B is a side view of the correction optical device seen in a direction represented by arrow E in FIG. 5A;

FIGS. 6A through 6C are schematic views of optical pickup devices in different examples according to the present invention; and

FIG. 7 is a schematic view of a conventional optical pickup device.

### DESCRIPTION OF THE PREFERRED EMBODIMENTS

Hereinafter, the present invention will be described by way of illustrative examples with reference to the accompanying drawings.

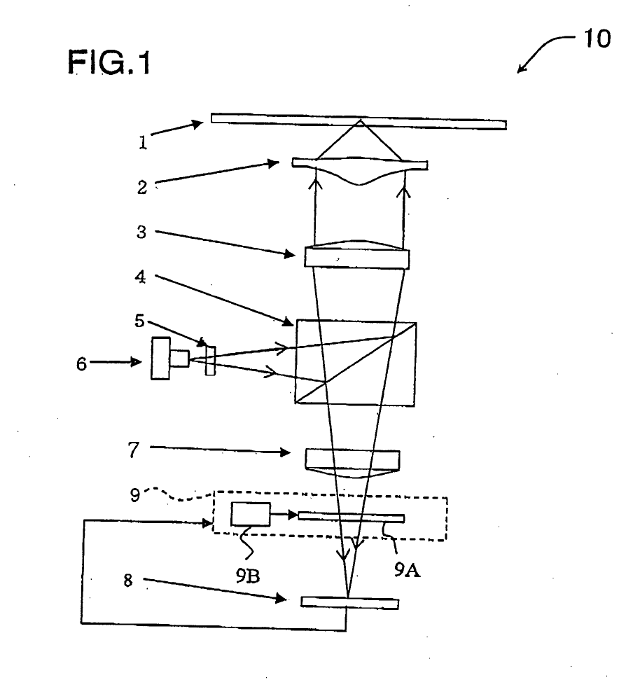

FIG. 1 is a schematic view of an optical pickup device 10 in an example according to the present invention.

On the optical pickup device 10, an optical disc 1 is mounted. An information recording medium mounted on the optical pickup device 10 is not limited to an optical disc, and may be any information recording medium on which information can be recorded using light. For example, the information recording medium may be a disc-shaped information medium such as, for example, an optomagnetic disc.

The optical pickup device 10 includes a plurality of optical elements. More specifically, the optical pickup device 10 includes an objective lens 2 for converging light, a collimator lens 3 for collimating light, a prism 4 for changing the optical path of light incident thereon in one direction by 90 degrees and allowing light incident thereon in a different direction to transmit therethrough, a diffraction grating 5 for diffracting light, a light source 6 such as a semiconductor laser device or the like, a cylindrical lens 7 acting as a focusing error generation optical device, a light detector 8 for receiving light reflected by the optical disc 1 and detecting information represented by the reflected light, and a correction optical device section 9 provided between the cylindrical lens 7 and the light detector 8.

The cylindrical lens 7 is an astigmatism generation device for causing astigmatism to the light reflected by the optical disc 1 and thus acts as a focusing error generation optical device for causing a focusing error to the reflected light.

The light detector 8 has a light receiving surface which is divided into a plurality of light receiving portions. The plurality of light receiving portions receive light reflected by the optical disc 1. In this example, the light detector 8 has four light receiving portions 8a, 8b, 8c and 8d (FIGS. 4A and 4B) but may have any other number of light receiving portions of two or more. The four light receiving portions are arranged adjacent to each other.

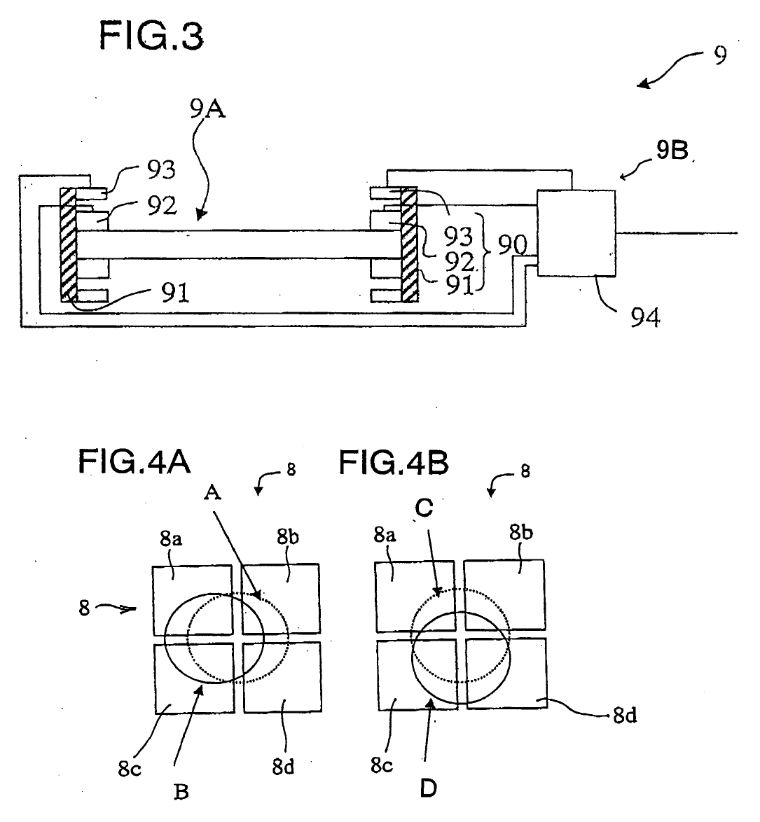

The correction optical device section 9 includes a correction optical device 9A for correcting a light path of the reflected light and a correction optical device control section 9B for controlling the correction optical device 9A such that the ratio of the light spot received by the plurality of light receiving portions is a prescribed value. The correction optical device 9A is, for example, flat plate-like and transparent. The correction optical device control section 9 will be described later in more detail with reference to FIG. 3. The correction optical device control section 9B is, for example, a location angle control section for controlling the angle of the correction optical device 9A with respect to the horizontal direction.

The optical pickup device 10 operates as follows. An optical beam which is emitted by the light source 6 passes through the diffraction grating 5 and is incident on the prism 4. The direction of the light is changed by the prism 4 by 90 degrees, and the light is incident on the collimator lens 3. The light is collimated by the collimator lens 3 and then is converged by the objective lens 2. The light then irradiates the optical disc 1. On the optical disc 1, a small light spot is formed.

The light which is reflected by the optical disc 1 passes through the objective lens 2 and is incident on the collimator lens 3. Then, the light passes through the collimator lens 3 and is incident on the prism 4. The light passes through the prism 4 and advances straight. Astigmatism is caused to the light by the cylindrical lens 7, and passes through the correction optical device section 9. Then, the light reaches the four light receiving portions of the light detector 8. By the correction optical device section 9 appropriately correcting the light path of the reflected light reaching the four light receiving portions of the light detector 8, the ratio of the light spot respectively received by the four light receiving portions is corrected to a prescribed value (for example, a value by which the light receiving portions receive an equal amount of light, i.e., the light spot is formed on the surface of the light detector 8 such that the light receiving portions 8a through 8d have an equal area of the light spot thereon).

In the following description, the ratio of the light spot respectively received by the four light receiving portions is also referred to as a “light receiving balance”.

The four light receiving portions and the optical elements included in the optical pickup device 10 may be arranged such that when light is collected on the optical disc 1 with no focal offset and a light spot is positioned at the center of a track on the optical disc 1, the four light receiving portions receive an equal amount of light.

The light received by each of the four light receiving portions of the light detector 8 is converted into an electric signal. By arithmetic processing of the electric signal, the information (reproduction information) recorded on the optical disc 1 and servo information including focusing error information represented by a focusing error signal (FES) are detected. Based on the detected information, the information recorded on the optical disc 1 is reproduced or erased, or information is recorded on the optical disc 1.

Light path correction performed by the correction optical device section 9 will be described in more detail below.

The correction optical device section 9 is located on a portion of a light path from the optical disc 1 to the plurality of light receiving portions, which does not overlap with the path from the light source 6 to the optical disc 1. In other words, the correction optical device section 9 is located on a light path from the prism 4 to the plurality of light receiving portions.

When the optical elements such as the collimator lens 3, the prism 4, the diffraction grating 5, the light source 6, the cylindrical lens 7 and the light detector 8 are positionally deviated due to long-time use or environmental changes, the ratio of the light spot received by the respective light receiving portions of the light detector 8 is changed from a prescribed value (for example, an initially set value by which the light receiving portions receive an equal amount of light, i.e., the light receiving portions have an equal area of the light spot thereon). When this occurs, the correction optical device section 9 adjusts the angle of the correction optical device 9A with respect to the horizontal direction so as to return the ratio back to the prescribed value.

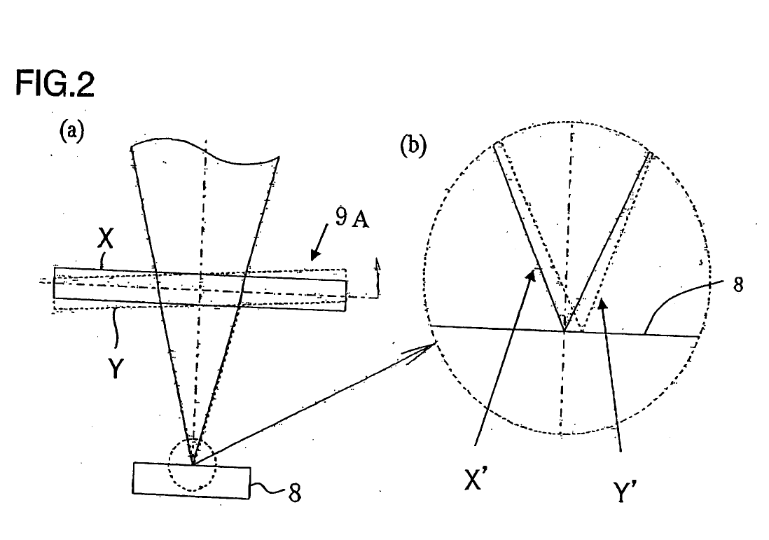

In FIG. 2, part (a) is a partial cross-sectional view of the optical pickup device 10, illustrating a change in the light path of the reflected light when the light receiving balance is corrected by the correction optical device 9A. Part (b) is a partial enlarged view of part (a) of FIG. 2.

When the correction optical device 9A is located substantially horizontally in a longitudinal direction thereof as represented by solid line X in part (a) of FIG. 2, a light spot is formed on the light detector 8 as represented by solid line X′ in part (b) of FIG. 2. When the position of the light spot formed on the light detector 8 is offset from a prescribed position, the ratio of the light spot received by the four light receiving portions is different from the prescribed value. When this occurs, the angle of the correction optical device 9A is changed from the horizontal direction as represented by dotted line Y in part (a) of FIG. 2. As a result, the light path is changed as represented by dotted line Y′ in part (b) of FIG. 2 by the refraction caused by the correction optical device 9A. The position of the light spot is changed to a desirable position, and the light receiving balance is returned to the prescribed set value (for example, the initially set value, by which the four light receiving portions receive an equal amount of light).

FIG. 3 is a schematic view of a correction optical device section 9 in one embodiment of the present invention.

The correction optical device section 9 includes the correction optical device 9A and the location angle control section as described above. The location angle control section is one embodiment of the correction optical device control section 9B. The location angle control section is also represented by reference numeral 9B for the sake of simplicity.

In FIG. 3, the location angle control section 9B includes a location optical device driving section 90 and a control circuit 94. The location optical device driving section 90 is provided at each of two ends of the correction optical device 9A and acts as a correction optical device driving section, capable of changing the angle of the correction optical device 9A with respect to the horizontal direction. The control circuit 94 controls the location optical device driving section 90 and thus controls the angle of the correction optical device 9A in accordance with the ratio of the light spot received by the plurality of light receiving portions. The control circuit 94 controls the location optical device driving section 90 based on a signal detected by the light detector 8.

The location optical device driving section 90 includes a holding member 91 for holding each respective end of the correction optical device 9A, a coil member 92 provided at each respective end of the correction optical device 9A, and a magnet member 93 attached to the holding member 91 so as to face the coil member 92. The coil member 92 and the magnet member 93 act together as an angle change section for electrically changing the angle of the correction optical device 9A with respect to the horizontal direction. A current is caused to flow through the coil member 92 to generate a magnetic force between the coil member 92 and the magnet member 93, and thus the correction optical device 9A is moved along the holding member 91. In this manner, the angle of the correction optical device 9A with respect to the horizontal direction is controlled.

With such a structure of the location optical device driving section 90, the control circuit 94 may be located outside the optical pickup device 10. In this case also, the angle of the correction optical device 9A can be controlled by electrically controlling the coil member 92 by the external control circuit 94. In the case where the control circuit 94 is mounted on the optical pickup device 10, it is not necessary to provide a separate external control circuit, which dispenses with the necessity of designing a circuit. Thus, the load regarding the external control circuit is alleviated.

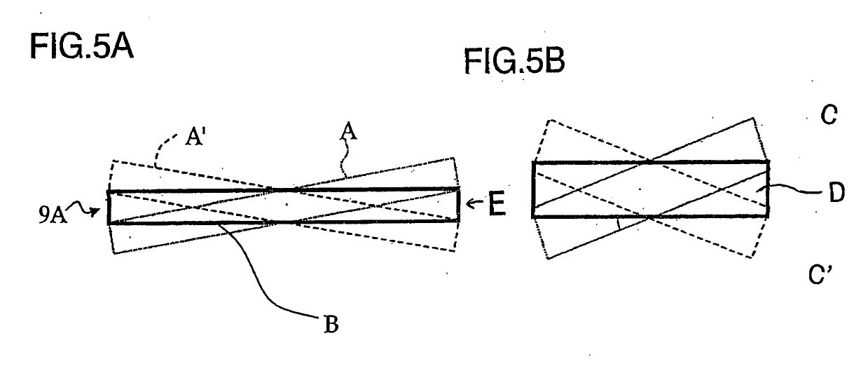

FIGS. 4A and 4B are each a plan view of the light detector 8 showing a position of the light spot formed on the four light receiving portions 8a through 8d. FIG. 5A is a side view of the correction optical device 9A seen in the same direction as in FIG. 1. FIG. 5A illustrates the operation of the correction optical device 9A when the light receiving balance is being corrected. FIG. 5B is a side view of the correction optical device 9A seen from a direction represented by arrow E in FIG. 5A.

As shown in FIGS. 4A and 4B, the light detector 8 includes four light receiving portions 8a through 8d which are arranged adjacent to each other.

With reference to FIG. 4A, dotted line circle A represents a light spot formed at a position with the normal light receiving balance on the light detector 8, and solid line circle B represents a light spot formed at a position with an offset light receiving balance on the light detector 8.

With the normal receiving balance, for example, the light spot is formed such that the four light receiving portion 8a through 8d have an equal area of the light spot thereon; i.e., the four light receiving portion 8a through 8d receive an equal amount of light. When the position of the light spot is offset from the normal position (dotted line circle A) in a radial direction (leftward; circle B), the angle of the correction optical device 9A with respect to the horizontal direction is adjusted, as shown in FIG. 5A, from the initial angle represented by solid line B to the angle represented by dotted line A. Thus, as described above with reference to parts (a) and (b) of FIG. 2, the light spot is adjusted to the position of normal light receiving balance as represented by dotted line circle A in FIG. 4A. In FIG. 5A, dashed line A′ represents an exemplary corrected angle of the correction optical device 9A when the position of the light spot is offset in the opposite direction from solid line circle B (i.e., rightward in FIG. 4A).

With reference to FIG. 4B, when the position of the light spot is offset from the normal position (dotted line circle C) in a tangential direction (downward; circle D), the angle of the correction optical device 9A with respect to the horizontal direction is adjusted, as shown in FIG. 5B, from the initial angle represented by solid line D to the angle represented by dotted line C. Thus, as described above with reference to parts (a) and (b) of FIG. 2, the light spot is adjusted to the position of normal light receiving balance as represented by dotted line circle C in FIG. 4B. In FIG. 5B, dashed line C′ represents an exemplary corrected angle of the correction optical device 9A when the position of the light spot is offset in the opposite direction from solid line circle D (i.e., upward in FIG. 4B).

A method for controlling the light receiving balance when the light receiving balance is destroyed by, for example, positional deviation of the optical elements will be described below in more detail.

While monitoring a focusing error signal representing a focusing error from the four light receiving portions, the objective lens 2 is moved along the optical axis (upward and downward in FIG. 1) of the optical pickup device 10 by an actuator or the like, so as to adjust the focusing position of the objective lens 2 and thus to reduce the focusing error.

Then, as shown in FIG. 2, while monitoring a tracking error signal from the four light receiving portions, the angle of the correction optical device 9A with respect to the horizontal direction is adjusted by the location optical device driving section 90, such that the ratio of the light spot received by the four light receiving portions is returned to the initially set value (for example, such that the four light receiving portions receive an equal area of the light spot).

After the adjustment, the angle of the correction optical device 9A is fixed.

In this manner, even when the optical elements are positionally deviated due to the long-time use or environmental changes of the optical pickup device 10 and as a result, the light receiving balance among the light receiving portions is offset from the initially set value, the light receiving balance can be adjusted back to the initially set value. Therefore, usual tracking control can be normally performed. This allows the optical pickup device 10 to keep its initial performance over a long period of time.

As described above, in this example, the correction optical device section 9 for correcting the light path is provided on a portion of a light path from the optical disc 1 to the plurality of light receiving portions of the light detector 8 which does not overlap with the light path from the light source 6 to the optical disc 1. Namely, the correction optical device section 9 is provided on the light path from the prism 4 to the plurality of light receiving portions. By causing an electric current to flow through the coil member 92 provided at each end of the correction optical device 9A and thus generating a prescribed magnetic force between the magnet member 93 and the coil member 92, the angle of the correction optical device 9A with respect to the horizontal direction is adjusted. As a result, the correction optical device 9A is tilted. This changes the direction of light passing through the correction optical device section 9 as a result of being refracted by the correction optical device 9A. Therefore, the ratio of the light spot received by the plurality of light receiving portions, which is offset from the initially set value (for example, the value by which the light receiving portions receive an equal area of the light spot), can be adjusted back to the initially set value. Thus, even when the light receiving balance among the plurality of (for example, four) light receiving portions are offset from the initially set value, the light receiving balance can be returned to the initially set value. Thus, the optical pickup device 10 can be used for a long period of time.

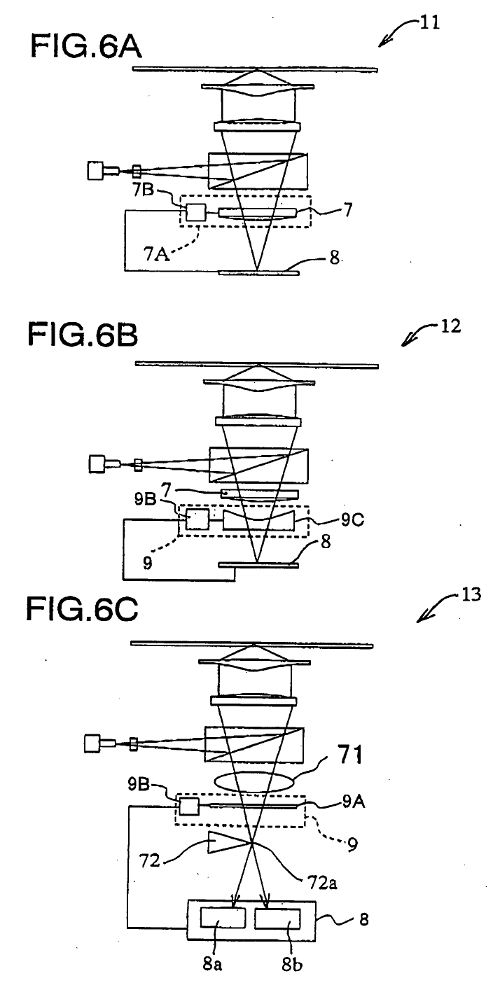

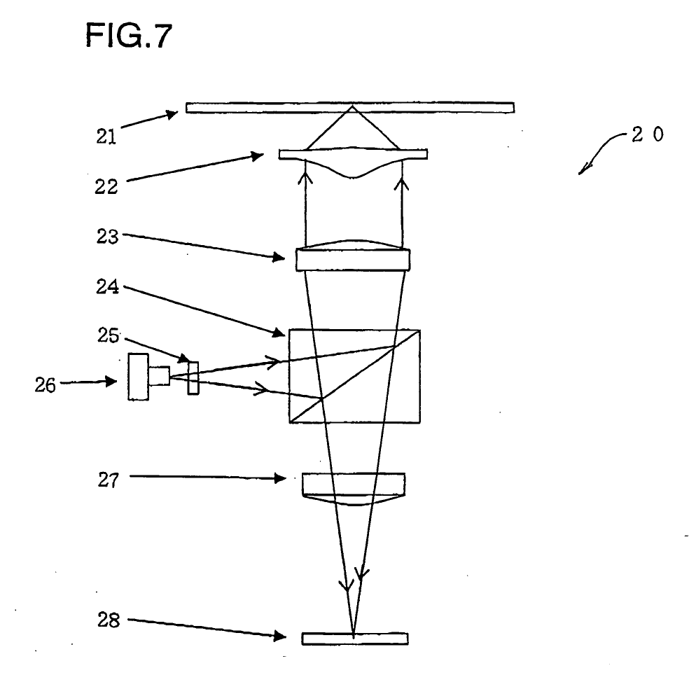

In this example, the light receiving balance is adjusted by controlling the angle of the correction optical device 9A. The present invention is not limited to use of the correction optical device section 9. Alternatively, the optical pickup device may be controlled as shown in FIGS. 6A through 6C in order to adjust the light receiving balance.

FIG. 6A is a schematic view of an optical pickup device 11 according to another example of the present invention.

The optical pickup device 11 is different from the optical pickup device 10 in that the optical pickup device 11 includes a correction optical device section 7A.

The correction optical device section 7A includes a cylindrical lens 7, which is an astigmatism generation device, and a correction optical device control section 7B. The correction optical device control section 7B includes a component which is similar to the location optical device driving section 90. The component is provided at each of two ends of the cylindrical lens 7. The correction optical device control section 7B controls the angle of the cylindrical lens 7 in accordance with the ratio of the light spot received by the four light receiving portions. Here, the cylindrical lens 7 acts as a correction optical device.

With the structure of the optical pickup device 11, the light receiving balance among the four light receiving portions can be adjusted, and also defocusing of the light spot formed on the four light receiving portions can be alleviated. The alleviation is performed by moving the cylindrical lens 7 along the optical axis (upward and downward in FIG. 6A). Since it is not necessary to separately provide the flat plate-like correction optical device 9A on the light path from the optical disc 1 to the plurality of light receiving portions, the number of components of the optical pickup device can be reduced.

FIG. 6B is a schematic view of an optical pickup device 12 according to still another example of the present invention.

The optical pickup device 12 includes a concaved lens 9C instead of the correction optical device 9A. The location optical device driving section 90 shown in FIG. 3 is provided at each of two ends of the concaved lens 9C. The angle of the concaved lens 9C is adjusted in accordance with the ratio of the light spot received by the four light receiving portions. Here, the concaved lens 9C acts as a correction optical device.

When the concaved lens 9C is used, the light detector 8 is allowed to be located at an arbitrary position which is different from the position thereof in FIG. 1 by changing the curvature of the concaved lens 9C.

In the above example, an astigmatism method is used as a system for detecting a focusing error signal representing a focusing error. The present invention is not limited to this, and other systems can be used.

FIG. 6C is a schematic view of an optical pickup device 13 according to still another example of the present invention.

The optical pickup device 13 uses a knife edge method for detecting a focusing error signal.

The optical pickup device 13 includes a collection lens 71 above the flat plate-like correction optical device 9A and a knife edge-like member 72 below the correction optical device 9A, instead of including the astigmatism generation device (e.g., the cylindrical lens 7) on the light path from the optical disc 1 to the light detector 8. The knife edge-like member 72 is provided at such a position that a pierced tip 72a thereof is located at the position where the reflected light is converged on the light path from the optical disc 1 to the light detector 8.

The light transmitted through the collection lens 71 is focused at the pierced tip 72a of the knife edge-like member 72, and is directed to two light receiving portions 8a and 8b as shown in FIG. 6C. The correction optical device 9A, which is, for example, like a flat plate, is provided on the light path from the optical disc 1 to the plurality of light receiving portions so as to adjust the angle of the correction optical device 9A with respect to the horizontal direction. Thus, the position of the focal point can be adjusted to the pierced tip 72a of the knife edge-like member 72.

Although not specifically described above, the correction optical device may be held by a damper or a member formed of a flexible resin material such as Hytrel®. In the case where the astigmatism method is used, the correction optical device may be controlled by an external control circuit such that (K+L)−(M+N)=0 or (K+N)−(L+M)=0. Here, K, L, M and N represent the light amount received by the four light receiving portions 8a, 8b, 8c and 8d shown in FIGS. 4A and 4B. The post-change angle of the correction optical device is kept by applying an offset voltage by an external circuit. The angle is kept in the state where the optical pickup device 10 is focus-servo-controlled. After the correction is completed, the tracking servo control is performed. When the knife edge method or the like is used, the correction optical device may be controlled by an external control circuit such that the difference in the light amounts received by the two light receiving portions (8a and 8b in FIG. 6C) is zero.

As described above, according to the present invention, even when the light receiving balance is offset by, for example, environmental changes or over-time changes due to long-time use, the light receiving balance can be adjusted (for example, to the balance by which the plurality of light receiving portions receive an equal amount of light) without re-adjusting the positions of the plurality of light receiving portions of the light detector. The performance of the optical pickup device can be kept for a long time.

In an embodiment where an astigmatism generation device included in the optical pickup device is used as the correction optical device, the number of components in the optical pickup device can be reduced.

The angle of the correction optical device with respect to the horizontal direction is controlled by an electric location angle control section. By mounting the control circuit of the location angle control section on the optical pickup device, the load on the external control circuit can be alleviated.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. An optical pickup device, comprising:
a light source for emitting light to an information recording medium;
a light detector including a plurality of light receiving portions, the light detector receiving light reflected by the information recording medium by the plurality of light receiving portions so as to detect information represented by the reflected light; and
a correction optical device section including a correction optical device for correcting a light path of the reflected light before the plurality of light receiving portions receive the reflected light, and a correction optical device control section for controlling the correction optical device such that a ratio of a light spot received by the plurality of light receiving portions is a prescribed value.

2. An optical pickup device according to claim 1, wherein the correction optical device section is located on a portion of a light path from the information recording medium to the plurality of light receiving portions, the portion not overlapping with a light path from the light source to the information recording medium.

3. An optical pickup device according to claim 1, wherein the correction optical device includes a flat plate-like transparent member or a concaved lens.

4. An optical pickup device according to claim 1, wherein the correction optical device includes a focusing error generation optical device for causing a focusing error to the reflected light.

5. An optical pickup device according to claim 4, wherein the focusing error generation optical device includes a cylindrical lens.

6. An optical pickup device according to claim 1, further comprising a focusing error generation optical device, located on the optical path from the information recording medium to the plurality of light receiving portions, for causing a focusing error to the reflected light.

7. An optical pickup device according to claim 6, wherein:
the focusing error generation optical device includes an astigmatism generation device for causing an astigmatism to the reflected light; and
the plurality of light receiving portions receive the reflected light to which the astigmatism is caused by the astigmatism generation device, and thus the light detector detects focusing error information representing the focusing error.

8. An optical pickup device according to claim 6, wherein the focusing error generation optical device includes a cylindrical lens.

9. An optical pickup device according to claim 1, wherein the correction optical device control section adjusts an angle of the correction optical device to correct the light path of the reflected light.

10. An optical pickup device according to claim 9, wherein the correction optical device control section includes a location angle control section for controlling the angle of the correction optical device with respect to a horizontal direction.

11. An optical pickup device according to claim 10, wherein the location angle control section includes:
a correction optical device driving section for changing the angle of the correction optical device with respect to the horizontal direction; and
a control section for controlling the correction optical device driving section in accordance with the ratio of the light spot received by the plurality of light receiving portions.

12. An optical pickup device according to claim 11, wherein:
the correction optical device driving section includes:
a coil member provided at an end of the correction optical device; and
a magnet member provided so as to face the coil member; and
the control section controls an electric current to be supplied to the coil member to generate a magnetic force between the coil member and the magnet member, so as to control the correction optical device driving section to change the angle of the correction optical device with respect to the horizontal direction.

13. An optical pickup device according to claim 1, further comprising a knife edge-like member having a pierced tip located at a position at which the reflected light is converged on the light path from the information recording medium to the plurality of light receiving portions; wherein:
the knife edge-like member causes a focusing error to the reflected light; and
the plurality of light receiving portions receive the reflected light to which the focusing error is caused by the knife edge-like member, and thus the light detector detects focusing error information representing the focusing error.

14. An optical pickup device according to claim 1, further comprising an objective lens, located on a light path from the light source to the information recording medium, for converging the light emitted by the light source on a surface of the information recording medium.

15. A method for controlling an optical pickup device, comprising the steps of:
correcting a light path of light reflected by an information recording medium by a correction optical device such that a ratio of a light spot received by the plurality of light receiving portions is a prescribed value; and
fixing the correction optical device which has corrected the light path of the reflected light.

16. A method according to claim 15, wherein the step of correcting includes the step of adjusting an angle of the correction optical device with respect to a horizontal direction.

17. A method according to claim 15, further comprising the step of locating the correction optical device on a portion of a light path from the information recording medium to the plurality of light receiving portions, the portion not overlapping with a light path from the light source to the information recording medium.

18. A method according to claim 15, further comprising the step of adjusting a distance between an objective lens and a surface of the information recording medium, the objecting lens being located on a light path from the light source to the information recording medium, such that the light emitted by the light source is converged on the surface of the information recording medium before the step of correcting.
